(19) United States
(12) Patent Application Publication
(10) Pub. No.: US 2010/0227504 A1
(43) Pub. Date: Sep. 9, 2010

(54) ELECTRICAL CONNECTOR WITH A SIMPLE STRUCTURE

(75) Inventors: CHEN-XI WANG, Kunshan (CN); HONG-QIANG HAN, Kunshan (CN); ZI-QIANG ZHU, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/718,527

(22) Filed: Mar. 5, 2010

(30) Foreign Application Priority Data
Mar. 5, 2009 (CN) 200920301090.2

(51) Int. Cl. H01R 9/03

(52) U.S. Cl. 439/607.41

(57) ABSTRACT

An electrical connector includes a housing, a number of contacts retained in the housing and a metal shell covering the housing to form a receiving space with the tongue portion for receiving an electrical plug. The housing has a base portion and a tongue portion extending forwardly from the base portion. The contacts consist of two pairs of differential signal contacts and a pair of grounding contacts between the two pairs of differential signal contacts. Each contact has a contact portion. All contact portions are arranged in a row on one side of the tongue portion.

### BACKGROUND OF THE INVENTION

1. Field of the Invention

The present invention relates to electrical connectors, more particularly to electrical connectors with a simple structure.

2. Description of Related Art

C type HDMI (High-Definition Multimedia Interface) connectors present as a medium being widely used in mobiles phones and other electronic devices for electrically connecting the electronic devices with each other to transmit signals. The C type HDMI connector has nineteen contacts arranged in one row and including three pairs of differential contacts (Data+ [symbol] Data−), a pair of clock contacts (Clock+ [symbol] Clock−), five grounding contacts, a CEC signal contact, a SCL signal contact, a SDA signal contact, a reserved signal contact, a +5V power contact, and a hot plug detect contact. It is to see that the C type HDMI connector has so many types of the contacts sorted in function that the chipset designed for the C type HDMI connector is complicated. The C type HDMI connector need many contacts to transmit so many different types of data, and the manufacturing costs of the C type HDMI connector is increased.

Hence, an improved electrical connector is desired to overcome the above problems.

### BRIEF SUMMARY OF THE INVENTION

According to one aspect of the present invention, an electrical connector comprises: a housing having a base portion and a tongue portion extending forwardly from the base portion; a plurality of contacts retained in the housing and consisting of two pairs of differential signal contacts and a pair of grounding contacts between the two pairs of differential signal contacts, each contact having a contact portion, all contact portions being arranged in a row on one side of the tongue portion; and a metal shell covering the housing to form a receiving space with the tongue portion for receiving an electrical plug.

According to another aspect of the present invention, an electrical connector assembly comprises: an electrical receptacle having a first housing, a plurality of first contacts retained therein and a first metal shell covering the first housing and forming a receiving space with the first housing, the first housing having a first base portion and a first tongue portion extending forwardly from the base portion, the first contacts consisting of two pairs of differential signal contacts and a pair of grounding contacts between the two pairs of differential signal contacts, the first metal shell having a first top wall with a spring arm extending into the receiving space; and an electrical plug mating with the electrical receptacle and having a second housing, a plurality of second contacts corresponding to the first contacts and electrically connecting with the first contacts and a second metal shell covering the second housing, the second housing having a second base portion and a second tongue portion extending forwardly from the second base portion, the second metal shell having a second top wall with an opening extending therethrough in an up to down direction to lock with the spring arm; wherein the first top wall defines at least a locking hole extending therethrough in the up to down direction, and the electrical plug further comprises at least a locking contact retained in the second housing to lock with the locking hole when the electrical plug is inserted into the receiving space.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an electrical receptacle with an electrical plug inserted therein according to the present invention;

FIG. 2 is a perspective view of the electrical receptacle and the electrical plug shown in FIG. 1;

FIG. 3 is a perspective view of the electrical receptacle shown in FIG. 1;

FIG. 4 is a front elevational view of the electrical receptacle shown in FIG. 3;

FIG. 5 is an exploded view of the electrical receptacle shown in FIG. 3;

FIG. 6 is a view similar to FIG. 5, while taken from a different aspect;

FIG. 7 is a front elevational view of the electrical plug shown in FIG. 1;

FIG. 8 is a partially exploded view of the electrical plug with a cable being taken off;

FIG. 9 is an exploded view of the electrical plug with the cable being taken off; and

FIG. 10 is a view similar to FIG. 9, while taken from a different aspect.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Reference will be made to the drawing figures to describe the present invention in detail, wherein depicted elements are not necessarily shown to scale and wherein like or similar elements are designated by same or similar reference numeral through the several views and same or similar terminology.

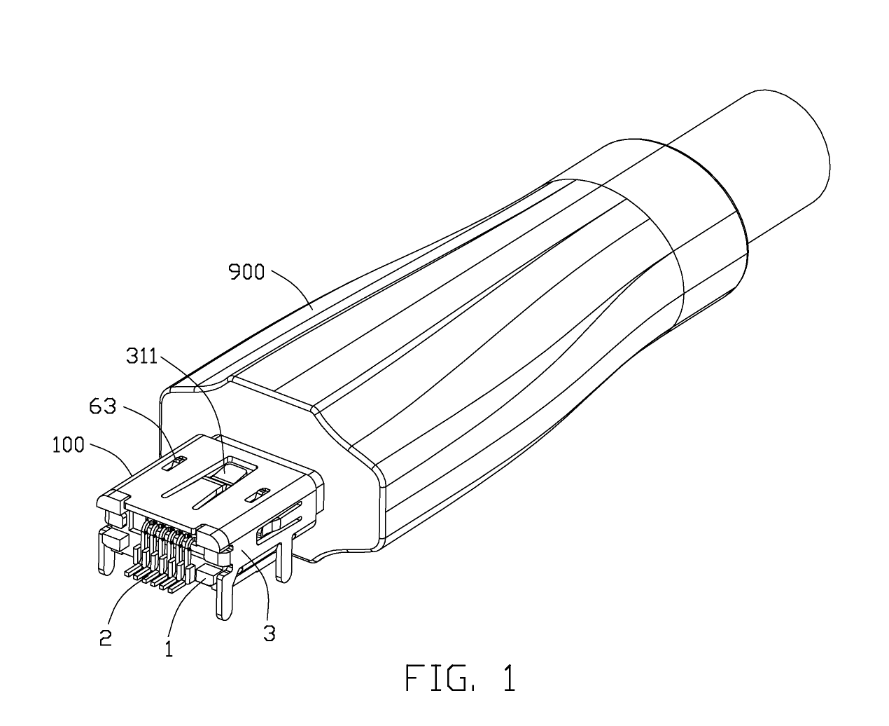

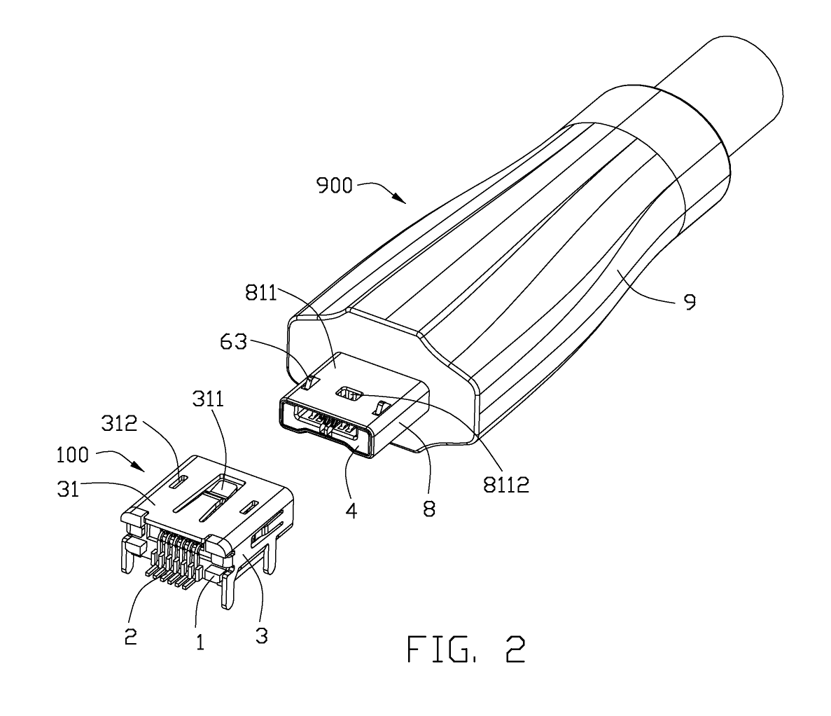

Referring to FIGS. 1-2, an electrical connector in the present invention is a miniature DiiVA (Digital Interactive Interface for Video & Audio) connector and comprises an electrical receptacle 100 and an electrical plug 900 mating with each other.

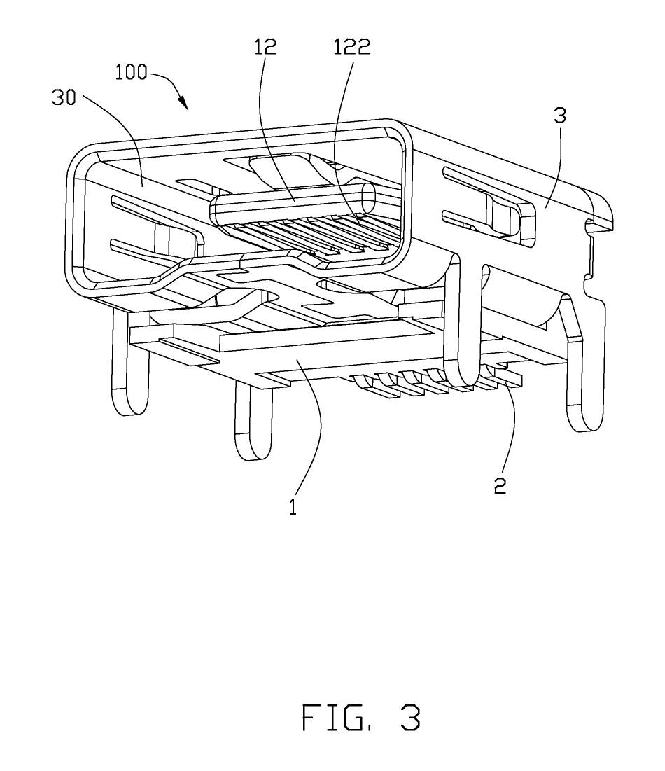

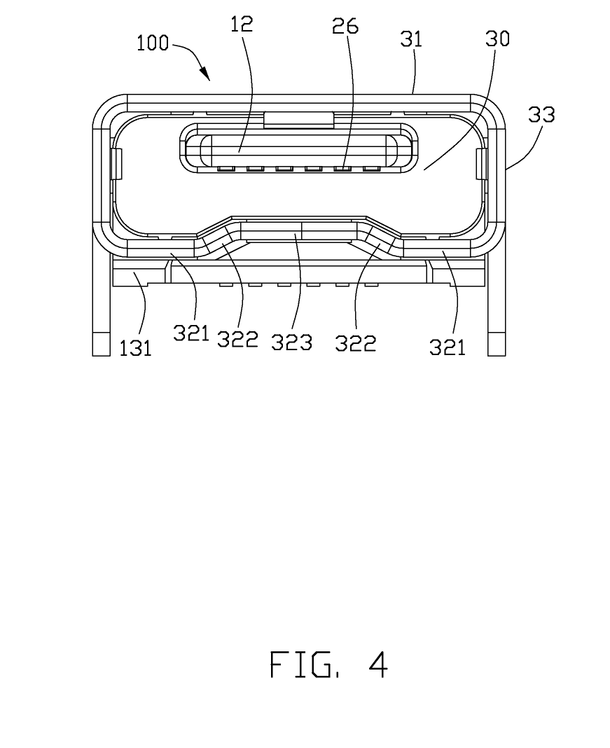

Referring to FIGS. 3-6, the electrical receptacle 100 comprises a first housing 1, a plurality of first contacts 2 retained in the first housing 1 and a first metal shell 3 covering the first housing 1 and forming a receiving space 30 with the first housing 1.

The first housing 1 comprises a first base portion 11 and a first tongue portion 12 unitarily extending forwardly from the first base portion 11. The first tongue 12 extends along a horizontal direction and defines an upper surface 121 and a lower surface 122. The upper surface 121 is formed with a protruding portion 1211 at a rear side thereof to stably hold the electrical plug 900. The lower surface 122 defines a plurality of alternate passageways 1221 extending through the first base portion 11 from front to back to receive the first contacts 2 and spacing the first contacts 2 to prevent the first contacts 2 from contacting or being crosstalk. The first housing 1 is made of insulative material and the first tongue portion 12 is integral with the first housing 1, of course, the first tongue portion 12 can be separated from the first housing 1 and mounted to the first housing 1 by an assemble process. Besides, the first housing 1 has an accessorial board 13 unitarily configured to be seated upon a circuit board (not shown) and formed on a bottom portion of the base portion 11 and spaced apart from the first tongue portion 12 along a vertical direction. The accessorial board 13 is parallel to the first tongue portion 12 and located below the first tongue portion 12. The accessorial board 13 has a pair of projections 131 extending forwardly. The first base portion 11 defines a groove 14 from a front lower side thereof to retain the first metal shell 3.

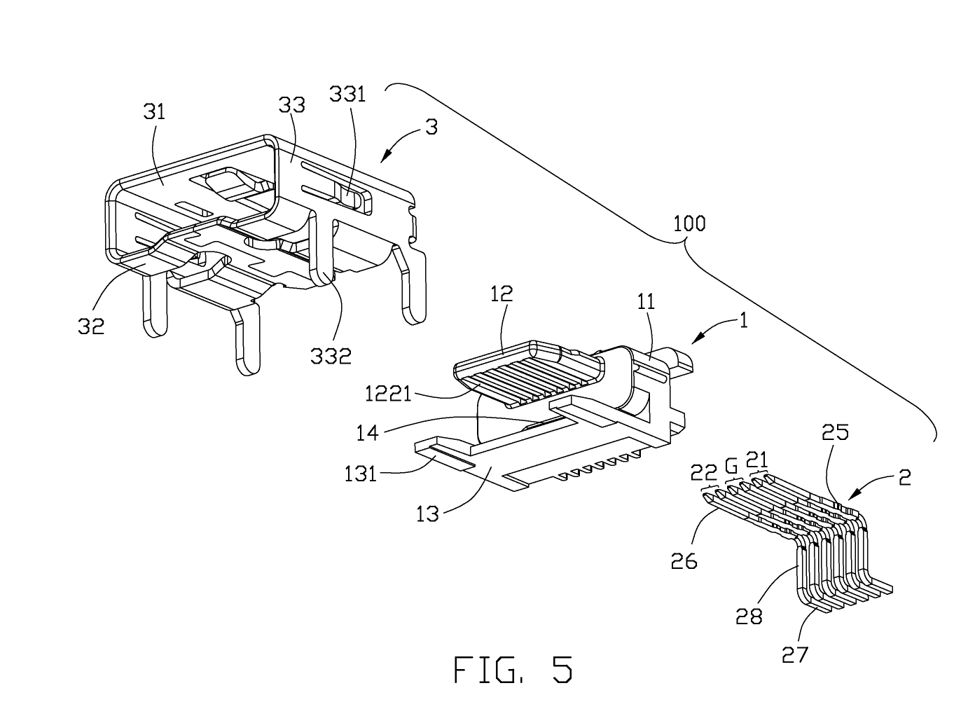

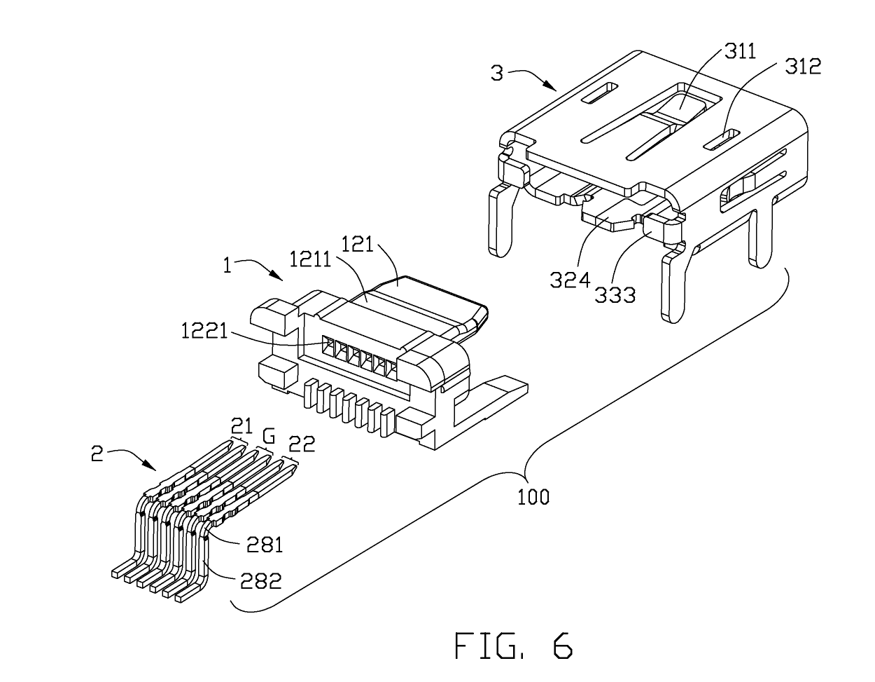

Referring to FIGS. 5 and 6, the first contacts 2 are categorized with two types of contacts which are differential signal contacts and grounding contacts, and the first contacts 2 consist of two pairs of differential signal contacts and a pair of grounding contacts G between the two pairs of differential signal contacts. One pair of the differential signal contacts are video signal contacts 21 used to unidirectionally transmit video signal, and another pair of differential signal contacts are hybrid signal contacts 22 used to bidirectionally transmit hybrid data signal. The first contacts 2 are arranged in a row along a transverse direction of the first housing 1 and arranged one after another as following: the pair of video signal contacts 21, the pair of grounding contacts G, the pair of hybrid signal contacts 22. Each pair of differential signal contacts comprise a + signal contact and a − signal contact. The pair of grounding contacts G are located between two pairs of differential signal contacts 21, 22, which can increase the distance between two pairs of differential signal contacts 21, 22, and reduce crosstalk between the adjacent two pairs of differential signal contacts 21, 22.

As described above, the first contacts 2 of the electrical receptacle 100 in the present invention comprise six contacts, which can simplify a structure of the electrical receptacle 100 and decrease a volume of the electrical receptacle 100 and the manufacture cost. Besides, the first contacts 2 are only categorized two types of contacts, which can simplify a design of corresponding circuit board (not shown) and chipset, and be convenient to popularize. In addition, the six contacts 2 comprise two pairs of differential signal contacts 21, 22 which can assure a high speed signal transmission.

Each first contact 2 has a retaining portion 25 retained in the first base portion 11, a flat contact portion 26 extending forwardly to the first tongue 12, a tail portion 27 extending out of the first housing 1 to connect with the circuit board, and a connecting portion 28 connecting the retaining portion 25 and the tail portion 27 together. The contact portions 26 extend horizontally and are partially received in the passageways 1121. The tail portions 27 are bended backwardly from a lower end of the connecting portions 28 and extend horizontally to be surface mounted to the circuit board. Each connecting portion 28 has a bending portion 281 bending downwardly from a rear end of the retaining portion 25 and a vertical portion 282 extending downwardly from a lower end of the bending portion 281. The bending portion 281 defines a width in the transverse direction of the first housing 1 and the width is smaller than that of the retaining portion 25 and the vertical portion 282, which can increase the distance between adjacent first contacts 2 for reducing crosstalk between the first contacts 2. The contact portions 26 are arranged in a row located at a same side of the first tongue 12, which can decrease a thickness of the first tongue 12, and the thickness of the electrical receptacle 100 can be decreased at the same time. The contact portions 26 are exposed to the receiving space 30 to contact with the electrical plug 900.

The first contacts 2 are stamped by a metal carrier and retained to the first housing 1 by an assemble process in the present invention. Of course, the first contacts 2 can be retained to the first housing 1 by an insert molding process in the other embodiment. Besides, a print circuit board (not shown) can replace the first tongue 12, and six metal figures soldered to the print circuit board can replace the contact portions 26, and using a transferring contact (not shown) to connects the metal figures and the circuit board.

The first metal shell 3 is stamped and bended by a metal sheet. The first metal shell 3 has a pair of opposed first top wall 31 and first bottom wall 32, a pair of first side walls 33 extending downwardly from two sides of the first top wall 31 and connecting with two sides of the first bottom wall 32. The receiving space 30 is surrounded by the first top wall 31, two first side walls 33 and the first bottom wall 32. The first bottom wall 32 has a pair of first walls 321 extending toward to each other from lower ends of the first side walls 33, a pair of second walls 322 obliquely and upwardly extending toward to each other from inner ends of the first walls 321, and a third wall 323 connecting the upper ends of the second walls 322 together. The first wall 321, third wall 323 and the first top wall 31 are parallel to each other, and the third wall 323 is located at an upper side of the first and second walls 321, 322. The first wall 321, second wall 322 and the third wall 323 form an anti-mismating mechanism to prevent an unmatchable plug from being inserted into the receiving space 30.

The projections 131 of the accessorial board 13 are located below the first walls 321 of the first bottom wall 32 to support the first metal shell 3 and prevent the first metal shell 3 from being distorted. The first top wall 32 has a spring arm 311 extending into the receiving space 30 from a middle position thereof in the transverse direction and a pair of locking holes 312 extending therethrough in an up to down direction to lock with the electrical plug 900. The locking holes 312 extend along an insertion direction of the electrical plug 900 and are symmetrically located at two sides of the spring arm 311. Each first side wall 33 has a spring tab 331 extending into the receiving space 30 to abut against the electrical plug 900. Each first side wall 33 has a pair of mounting legs 332 extending downwardly from a lower side thereof to position the electrical receptacle 100 to the circuit board. The first metal shell 3 has a pair of barbs 333 bending inwardly from a rear end of the first side walls 33 to lock with a rear end of the first housing 1. The third wall 323 has a fastening strip 324 extending backwardly to engage with the groove 14.

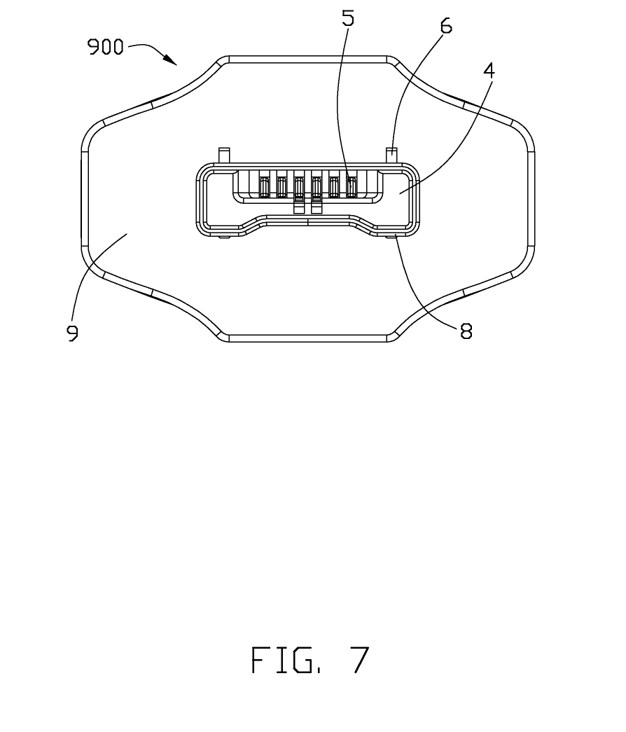

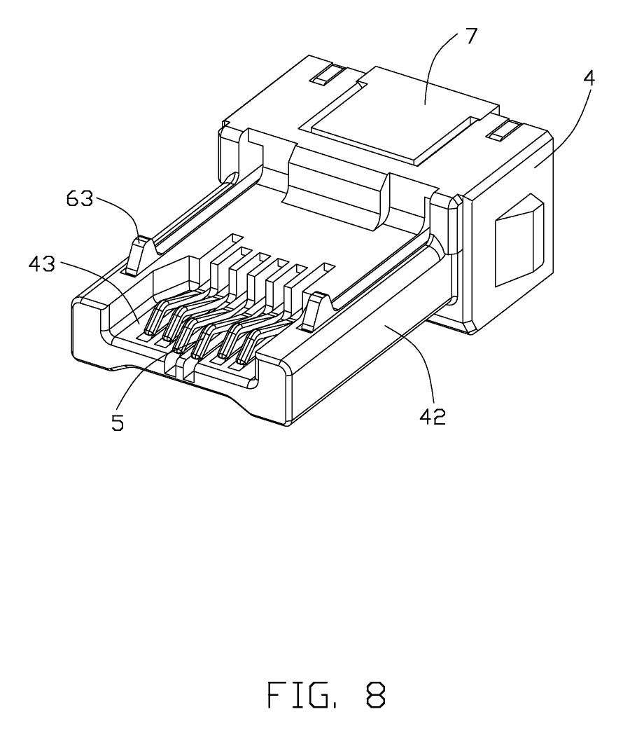

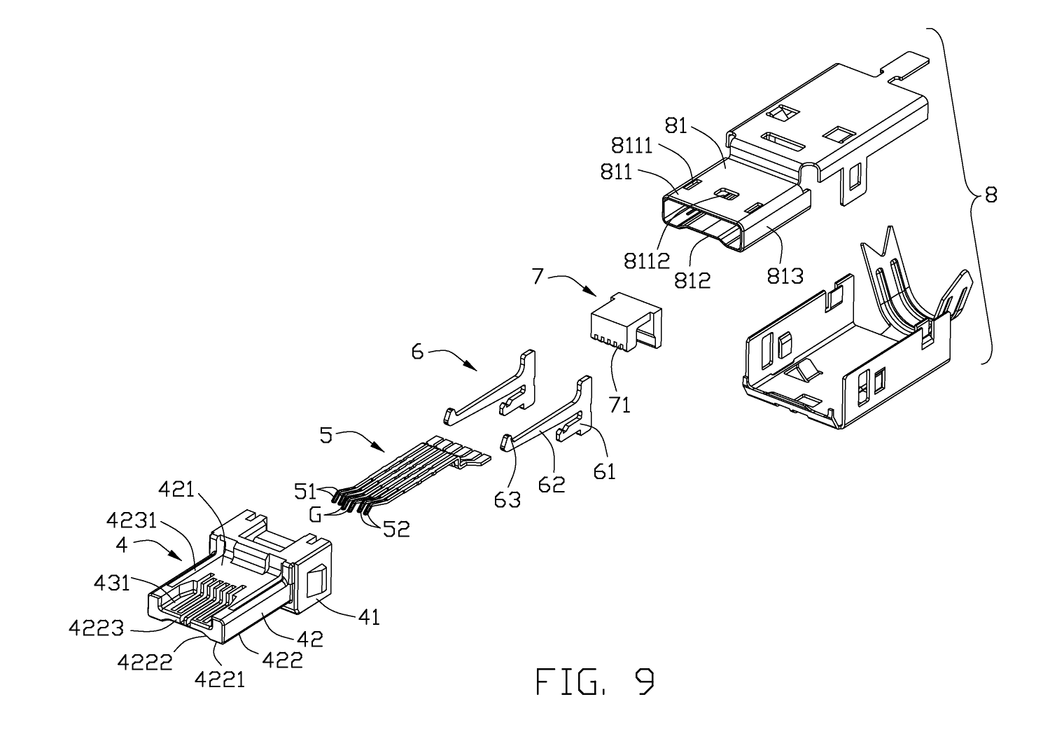

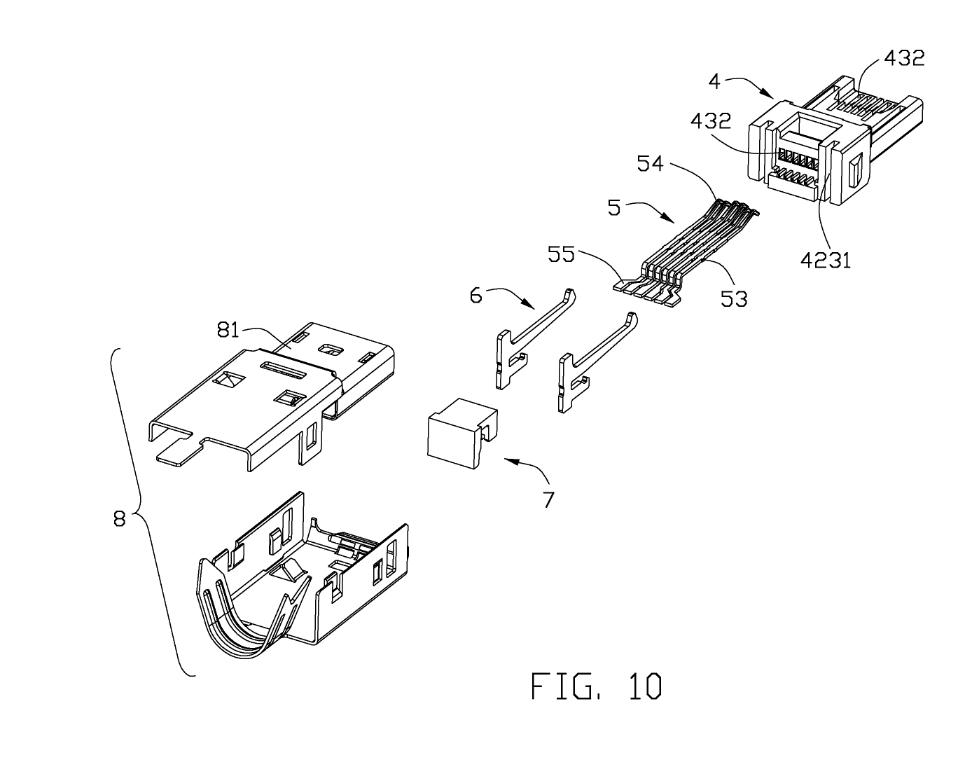

Referring to FIGS. 1, 2 and 7-10, the electrical plug 900 of the present invention comprises a second housing 4, a plurality of second contacts 5 and a pair of locking contacts 6 retained in the second housing 4, a spacer 7 positioning the second contacts 5, a second metal shell 8 covering the second housing 4 and a cable 9 connected at a rear end thereof.

The second housing 4 has a second base portion 41 and a second tongue portion 42 extending forwardly from the second base portion 41. The second tongue 42 has an upper surface 421 and a lower surface 422. The second tongue 42 defines a receiving cavity 43 recessed from a front side of the upper surface 421 and extending through a front end thereof. The receiving cavity 43 is formed with a bottom surface 431. The lower surface 422 of the second tongue portion 42 is flexible and designed corresponding to the first bottom wall 32 of the first metal shell 3. The lower surface 422 comprises a pair of first surfaces 4221 at two lower sides thereof, a pair of second surface 4222 extending inwardly and upwardly from an inner ends of the first surfaces 4221, and a third surface 4223 connecting the second surfaces 4222. The first surfaces 4221, the third surface 4223 and the upper surface 421 are parallel to each other, and the third surface 4223 is located at an upper side of the first surface 4221. When the electrical plug 900 is inserted into the receiving space 30, the first tongue portion 12 is received in the receiving cavity 43 of the second tongue portion 42, and the first surfaces 4221, second surfaces 4222 and third surface 4223 are located at an upper side of the first walls 321, second walls 322 and the third wall 323 respectively.

The second tongue 42 defines a plurality of passageways 432 recessed from the bottom surface 431 and extending through a rear end of the second base portion 41. Each second contact 5 has a flexible contact portion 54 cantileveredly received in the passageways 432 and protruding into the receiving cavity 43. The second tongue portion 42 defines a pair of slots 4231 extending therethrough from the upper surface 421 to the lower surface 422 at two outsides of the receiving cavity 43 thereof. The locking contacts 6 are retained in the slots 4231. Each locking contact 6 has a locking portion 63 extending out of the upper surface 421 to lock with the locking holes 312.

The second contacts 5 are designed corresponding to the first contacts 2 and consist of two pairs of differential signal contacts and a pair of grounding contacts between the two pairs of differential signal contacts. One pair of the differential signal contacts are video signal contacts 51 used to unidirectionally transmit video signal, and another pair of differential signal contacts are hybrid signal contacts 52 used to bidirectionally transmit hybrid data signal. The pair of grounding contacts G are located between two pairs of differential signal contacts 51, 52, which can increase the distance between two pairs of differential signal contacts 51, 52, and reduce crosstalk between the adjacent two pairs of differential signal contacts 51, 52. A front end of the grounding contacts G are located at a front side of front ends of all differential signal contacts 51, 52, therefore, in the insertion process of the electrical plug 900, the grounding contacts G of the electrical plug 900 can contact with that on the electrical receptacle 100 earlier than the differential signal contacts, which can eliminate interference from outside.

Each second contact 5 has a retaining portion 53 retained in the second base portion 41, a said contact portion 54 extending forwardly from the retaining portion 53 and a connecting portion 55 extending backwardly from a rear end of the retaining portion 53 to connect with the cable 9.

The second contacts 5 of the electrical plug 900 in the present invention comprise six contacts, which can simplify a structure of the electrical plug 900 and decrease a volume of the electrical plug 900, and the manufacture cost of the cable 9. In addition, the six contacts 5 comprise two pairs of differential signal contacts 51, 52 which can assure a high speed signal transmission.

Each locking contact 6 has a securing portion 61 positioned in the slot 4231 and an arm portion 62 extending forwardly from the securing portion 61. The arm portion 62 is received in the slot 4231 and can moves in the up to down direction. The locking portion 63 extends upwardly from a front end of the arm portion 62 and can moves in the up to down direction.

The spacer 7 is mounted at a rear side of the second housing 4 and has a plurality of ribs 71 to separate the adjacent two second contacts 5 for prevent the second contacts 5 from contacting with each other.

The second metal shell 8 has a mating portion 81 surrounding the second tongue 42. The mating portion 81 has a second top wall 811, two second side walls 812 and a second lower wall 812 leaning to the upper surface 421, two sides and the lower surface 422 respectively. The second lower wall 812 is designed corresponding to the lower surface 422 and first lower wall 32 to mate with the electrical receptacle 100. The second top wall 811 defines a pair of holes 8111 and an opening 8112 between the holes 8111 to lock with the spring arm 311 of the electrical receptacle 100. The locking portion 63 of the locking contact 6 extends through the holes 8111 to an upper side of the top wall 811 to lock with the locking hole 312 of the electrical receptacle 100. Therefore, the spring arm 311 and the opening 8112 form a first locking mechanism, and the locking portions 63 and locking holes 312 form a second locking mechanism, the first and second locking mechanism make the electrical receptacle and electrical plug connect with each other stably to assure a stable signal transmission between the electrical receptacle and the electrical plug.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. An electrical connector, comprising:
a housing having a base portion and a tongue portion extending forwardly from the base portion;
a plurality of contacts retained in the housing and consisting of two pairs of differential signal contacts and a pair of grounding contacts between the two pairs of differential signal contacts, each contact having a contact portion, all contact portions being arranged in a row on one side of the tongue portion; and
a metal shell covering the housing to form a receiving space with the tongue portion for receiving an electrical plug.

2. The electrical connector as claimed in claim 1, wherein one pair of the differential signal contacts unidirectionally transmit video signal, and another pair of differential signal contacts bidirectionally transmit hybrid data signal.

3. The electrical connector as claimed in claim 1, wherein the tongue has an upper surface and a lower surface, the upper surface is formed with a protruding portion at a rear side thereof for stably holding a corresponding plug.

4. The electrical connector as claimed in claim 3, wherein the lower surface defines a plurality of passageways extending through the base portion from front to back to receive the contact portions.

5. The electrical connector as claimed in claim 1, wherein the housing has an accessorial board unitarily configured to be seated upon a circuit board and formed on a bottom portion of the base portion and spaced apart from the tongue portion along a vertical direction, and the accessorial board is located below the tongue portion and parallel with the tongue portion.

6. The electrical connector as claimed in claim 5, wherein the metal shell has a bottom wall located between the tongue portion and the accessorial board along the vertical direction, and the accessorial board has a pair of projections located at a lower side of the bottom wall to support the metal shell and prevent the metal shell from being distorted.

7. The electrical connector as claimed in claim 1, wherein the metal shell has a pair of opposed top wall and bottom wall, and a pair of opposed side walls bending from two sides of the top wall and connecting the bottom wall, the bottom wall is form with a pair of first walls extending toward to each other from lower ends of the side walls, a pair of second walls extending inwardly and upwardly from inner ends of the first walls, and a third wall connecting the upper ends of the second walls together.

8. The electrical connector as claimed in claim 7, wherein the first wall, third wall and the top wall are parallel to each other, and the third is located at an upper side of the first and second wall.

9. The electrical connector as claimed in claim 7, wherein the top wall has a spring arm extending into the receiving space and a pair of locking holes extending therethrough from up to down at two sides of the spring arm to lock with a corresponding plug.

10. The electrical connector as claimed in claim 1, wherein each contact has a retaining portion retained in the housing, a tail portion extending out of the housing to connect with a circuit board and a connecting portion connecting the retaining portion and the tail portion, and the connecting portion has a bending portion bending from a rear end of the retaining portion and a vertical portion connecting with the tail portion, the bending portion defines a width which is smaller than that of the vertical portion.

11. An electrical connector assembly, comprising:
an electrical receptacle having a first housing, a plurality of first contacts retained therein and a first metal shell covering the first housing and forming a receiving space with the first housing, the first housing having a first base portion and a first tongue portion extending forwardly from the base portion, the first contacts consisting of two pairs of differential signal contacts and a pair of grounding contacts between the two pairs of differential signal contacts, the first metal shell having a first top wall with a spring arm extending into the receiving space; and
an electrical plug mating with the electrical receptacle and having a second housing, a plurality of second contacts corresponding to the first contacts and electrically connecting with the first contacts and a second metal shell covering the second housing, the second housing having a second base portion and a second tongue portion extending forwardly from the second base portion, the second metal shell having a second top wall with an opening extending therethrough in an up to down direction to lock with the spring arm;
wherein the first top wall defines at least a locking hole extending therethrough in the up to down direction, and the electrical plug further comprises at least a locking contact retained in the second housing to lock with the locking hole when the electrical plug is inserted into the receiving space.

12. The electrical connector assembly as claimed in claim 11, wherein the first contacts are arranged in a row, and each first contact has a contact portion extending to one side of the first tongue.

13. The electrical connector assembly as claimed in claim 11, wherein one pair of the differential signal contacts unidirectionally transmit video signal, and another pair of differential signal contacts bidirectionally transmit hybrid data signal.

14. The electrical connector assembly as claimed in claim 11, wherein the spring arm is located at a middle position of the first top wall in a transverse direction.

15. The electrical connector assembly as claimed in claim 14, wherein the first top wall defines a pair of said locking holes, and the electrical plug has a pair of locking contacts to engage with the locking holes.

16. The electrical connector assembly as claimed in claim 15, wherein the second tongue portion defines a pair of slots extending therethrough along the up to down direction and a plurality of passageways between the slots to receive the second contacts, and the locking contacts each has a securing portion positioned in the base portion, an arm portion extending forwardly from the securing portion and received in the slot, and a locking portion extending upwardly from a front end of the arm portion to lock with the locking holes, and the arm portion can drive the locking portion moving in the up to down direction.

17. An electrical connector assembly comprising:
a first connector including:
a first insulative housing having a base with a mating tongue forwardly extending therefrom along a mating direction, said mating tongue defining opposite first and second faces thereon in a vertical direction perpendicular to said mating direction;
a first metallic shell assembled to the first housing and cooperating with the first housing to form a first mating port; and
a plurality of first contacts disposed in the housing, each of said contact defining a straight contact section exposed upon the first face; wherein
the mating tongue defines a first wedged structure in the vertical direction and a second wedge structure in a transverse direction perpendicular to both said mating direction and said vertical direction so as to ease mating with a second connector.

18. The electrical connector assembly as claimed in claim 17, wherein the first wedged structure is offset from the second wedged structure in the mating direction.

19. The electrical connector assembly as claimed in claim 18, wherein the first shell defines a spring arm having an apex essentially located in front of the first wedged structure while behind the second wedged structure in said mating direction.
